(19) United States
(12) Patent Application Publication
(10) Pub. No.: US 2006/0211787 A1
(43) Pub. Date: Sep. 21, 2006

(54) Surface functionalized absorbable medical devices

(76) Inventor: Shalaby W. Shalaby, Anderson, SC (US)

Correspondence Address: LEIGH P. GREGORY;ATTORNEY AT LAW, PO BOX 168, CLEMSON, SC, 29633-0168, US

(21) Appl. No.: 11/378,104

(22) Filed: Mar. 17, 2006

Related U.S. Application Data
(60) Provisional application No. 60/662,852, filed on Mar. 17, 2005.

(51) Int. Cl. C08J 3/28

(52) U.S. Cl. 522/134

(57) ABSTRACT

Absorbable, polymeric medical devices or components thereof are surface functionalized with succinic and/or homosuccinic acid anhydride groups which can be further hydrolyzed to the corresponding dicarboxylic acid groups for immobilizing multivalent metal ions, such as calcium ions, or reacted with hydroxyl- or amine-bearing reagents which can be biologically active.

The present application claims the benefit of prior provisional application U.S. Ser. No. 60/662,852, filed Mar. 17, 2005.

### FIELD OF THE INVENTION

The invention relates to surface functionalized polymeric medical devices having covalently bonded carboxylic acid anhydride groups and/or their hydrolysis products which are useful for covalent and/or ionic conjugation with hydroxy- and/or amine-bearing reagents and particularly bioactive agent(s) and immobilization of metallic ions, or basic monomers for directed surface polymerization into adherent coating, when the surface functionalities are predominantly free carboxylic acid groups.

### BACKGROUND OF THE INVENTION

Biocompatible, biodegradable, or absorbable polymers for various biomedical applications, such as those used in sutures and tissue engineering, have been described in “Functionalized Polyester Graft Copolymers,” (Hrkach et al., U.S. Pat. No. 5,654,381, issued Aug. 5, 1997). Poly-dl-lactide randomly grafted with acrylic acid was prepared and used to bind, covalently, proteins and peptides to the polyacrylic grafts, pending at random sites along the poly-dl-lactide chains [G. C. M. Steffens et al., Biomaterials, 23, 3523 (2002)]. In copending U.S. Publ. No. 2004-0132923 A1, the present inventor described absorbable heterochain polymers carrying acid or basic groups capable of ionic conjugation with basic or acidic bioactive agents, respectively. These polymers are produced by free-radical addition of unsaturated functional monomers onto absorbable liquid polymers and subsequent generation of reactive functionality or by direct copolymerization of a carboxylic initiator with cyclic monomers to produce liquid carboxyl-bearing copolymers or polyester carbonates.

However, none of the prior art of absorbable polymers addressed the surface activation of preformed absorbable medical devices with reactive carboxylic groups, in spite of the growing need for such surface-activated devices in the areas of tissue engineering, pharmacologically active devices, and biotechnological processes requiring precise control of cellular and critical biological events. The deficiency of the prior art regarding this subject may be related to the difficulty in conducting a chemical reaction on absorbable, easy-to-degrade, polymeric substrates. This provided a strong incentive to pursue the present invention and to explore surface functionalization of preformed medical and pharmaceutical absorbable devices with covalently bonded, reactive carboxylic functionalities, which are linked to the chains of constituent polymers at the surface, under controlled conditions that do not compromise physical integrity of the absorbable device. Hence, the invention is directed toward the surface functionalized absorbable medical and pharmaceutical devices with covalently bonded reactive carboxylic functionalities and applications of the devices.

### SUMMARY OF THE INVENTION

This invention deals with a surface functionalized absorbable medical device having succinic acid anhydride groups predominantly attached to constituent polymeric chains at the surface of the medical device through carbon-carbon covalent single bonds, wherein the succinic anhydride groups are hydrolyzed to generate the corresponding dicarboxylic groups. When the device is in the form of a fibrous or similarly porous construct, the dicarboxylic functionalities are reacted with a water-soluble calcium-containing compound to create a surface with ionically immobilized calcium ions. This can thus be used as a scaffold for tissue engineering.

One aspect of this invention deals with a surface functionalized absorbable medical device having succinic acid anhydride groups predominantly attached to constituent polymeric chains at the surface of the medical device through carbon-carbon covalent single bonds, wherein the succinic anhydride groups are reacted with at least one basic compound to generate the corresponding amic acid or imide derivatives.

A specific aspect of this invention deals with a process for producing a surface functionalized absorbable medical device having succinic acid anhydride groups predominantly attached to constituent polymeric chains at the surface of the medical device through carbon-carbon covalent single bonds, wherein the process requires reacting the polymeric device with a maleic anhydride solution containing a free-radical initiator, which may also contain an activator for the free-radical initiator.

Another specific aspect of this invention deals with a process for producing a surface functionalized absorbable medical device having succinic acid anhydride groups predominantly attached to constituent polymeric chains at the surface of the medical device through carbon-carbon covalent single bonds, wherein the process requires reacting the polymeric device with maleic anhydride in the presence of a high-energy radiation such as ultraviolet rays, gamma rays, or electron beam.

This invention also deals with a surface functionalized absorbable medical device having homosuccinic acid anhydride groups predominantly attached to constituent polymeric chains at the surface of the medical device through a carbon-carbon covalent single bond, wherein the homosuccinic anhydride groups can be hydrolyzed to generate the corresponding dicarboxylic acid groups.

Another specific aspect of this invention deals with a process for producing a surface functionalized absorbable medical device having homosuccinic acid anhydride groups predominantly attached to constituent polymeric chains at the surface of the medical device through a carbon-carbon covalent single bond, wherein the process requires that the surface is pretreated with a solution of itaconic anhydride and a free radical initiator and then heated above 25° C. to covalently react the double bond of the anhydride with the constituent polymeric chain yielding homosuccinic anhydride side groups.

Another specific aspect of this invention deals with a process for producing a surface functionalized absorbable medical device having homosuccinic acid anhydride groups predominantly attached to constituent polymeric chains at the surface of the medical device through a carbon-carbon covalent single bond, wherein the process requires pretreating the surface with a solution of itaconic anhydride, drying under nitrogen, and irradiating the surface with a high-energy radiation such as ultraviolet rays, gamma rays, and electron beam.

A broad aspect of this invention deals with a surface functionalized absorbable medical device having both succinic acid anhydride and homosuccinic acid anhydride groups predominantly attached to constituent polymeric chains at the medical device surface through carbon-carbon covalent single bonds.

### DETAILED DESCRIPTION OF PREFERRED EMBODIMENTS

The present invention is generally directed to the foregoing needs associated with producing absorbable medical and pharmaceutical devices, or components thereof, on which a functionalized surface can be created without compromising the physical integrity and bulk properties of the devices, but allows their surfaces to be further chemically tailored to permit the immobilization of calcium ions and other desirable bioactive agents to facilitate bone formation about the surface. The surface activated devices, subject of this invention, are capable of covalently binding certain hydroxylic or amino compounds which can be biologically or pharmacologically active in directing specific desirable biological or cellular effects, such as cell attachment/propagation and soft tissue regeneration. Typical examples of these surface functionalized devices may include, but are not limited to, absorbable sutures, meshes, and similar textile constructs such as non-woven microdenier fabrics, microfibrous electrospun fabrics, and other related textile constructs that can be used in tissue repair, tissue augmentation, or total tissue replacement through tissue engineering. Although throughout the present application addresses surface functionalized medical devices, it is to be understood that the present invention is also directed to one or more components of a medical device, wherein the entire device may or may not be surface functionalized as described herein.

Specifically, the present invention is directed to the production of functionalized surfaces having one or more types of dicarboxylic acid anhydride groups covalently bonded to the constituent polymeric chain about the surface through a covalent carbon-carbon single bond. More specifically, the dicarboxylic acid anhydride groups can be in the form of succinic anhydride or homosuccinic anhydride derived from maleic anhydride or itaconic anhydride, respectively, through the interaction of the parent anhydride double bond with the substrate polymeric chain in the presence of a free-radical initiator, such as benzoyl peroxide, 2,2′-azo-bis-butyronitrile, or di-t-butyl peroxide at the proper temperature with or without a free-radical activator, such as N,N′-dimethyl toluidine. Alternatively, the unsaturated anhydrides can be covalently bonded to the substrate polymeric chain in the presence of high-energy radiation such as ultraviolet, gamma rays, and electron beam.

More specifically, the invention focuses on dicarboxylic acid functionalities. This is to provide a unique dual effect of highly reactive cyclic anhydride that can be reacted effectively with hydroxyl- and amine-bearing agents, including bioactive ones. Hydrolysis products of these anhydrides are capable of binding, effectively, multivalent metallic ions and one or more bioactive agent(s) which are critical for modulation of one or more biological and cellular event(s) associated with treating site infection, wound healing, soft or hard tissue regeneration, and related processes of relevance to the field of tissue engineering. The functionalized surfaces comprising dicarboxylic acid groups may be used as substrates for in situ formation of electroconductive coating, such as that derived from pyrrole.

This invention deals with a surface functionalized absorbable medical device having succinic acid anhydride groups predominantly attached to constituent polymeric chains at the surface of the medical device through carbon-carbon covalent single bonds, wherein the succinic anhydride groups are hydrolyzed to generate the corresponding dicarboxylic groups. When the device is in the form of a fibrous or similarly porous construct, the dicarboxylic functionalities are reacted with a water-soluble calcium-containing compound to create a surface with ionically immobilized calcium ions. This can thus be used as a scaffold for tissue engineering.

One aspect of this invention deals with a surface functionalized absorbable medical device having succinic acid anhydride groups predominantly attached to constituent polymeric chains at the surface of the medical device through carbon-carbon covalent single bonds, wherein the succinic anhydride groups are reacted with at least one basic compound to generate the corresponding amic acid or imide derivatives.

A specific aspect of this invention deals with a process for producing a surface functionalized absorbable medical device having succinic acid anhydride groups predominantly attached to constituent polymeric chains at the surface of the medical device through carbon-carbon covalent single bonds, wherein the process requires reacting the polymeric device with a maleic anhydride solution containing a free-radical initiator, which may also contain an activator for the free-radical initiator.

Another specific aspect of this invention deals with a process for producing a surface functionalized absorbable medical device having succinic acid anhydride groups predominantly attached to constituent polymeric chains at the surface of the medical device through carbon-carbon covalent single bonds, wherein the process requires reacting the polymeric device with maleic anhydride in the presence of a high-energy radiation such as ultraviolet rays, gamma rays, and electron beam.

This invention also deals with a surface functionalized absorbable medical device having homosuccinic acid anhydride groups predominantly attached to constituent polymeric chains at the surface of the medical device through a carbon-carbon covalent single bond, wherein the homosuccinic anhydride groups can be hydrolyzed to generate the corresponding dicarboxylic acid groups.

Another specific aspect of this invention deals with a process for producing a surface functionalized absorbable medical device having homosuccinic acid anhydride groups predominantly attached to constituent polymeric chains at the surface of the medical device through a carbon-carbon covalent single bond, wherein the process requires that the surface is pretreated with a solution of itaconic anhydride and a free radical initiator and then heated above 25° C. to covalently react the double bond of the anhydride with the constituent polymeric chain yielding homosuccinic anhydride side groups.

Another specific aspect of this invention deals with a process for producing a surface functionalized absorbable medical device having homosuccinic acid anhydride groups predominantly attached to constituent polymeric chains at the surface of the medical device through a carbon-carbon covalent single bond, wherein the process requires pretreating the surface with a solution of itaconic anhydride, drying under nitrogen, and irradiating the surface with a high-energy radiation such as ultraviolet rays, gamma rays, and electron beam.

A broad aspect of this invention deals with a surface functionalized absorbable medical device having both succinic acid anhydride and homosuccinic acid anhydride groups predominantly attached to constituent polymeric chains at the medical device surface through carbon-carbon covalent single bonds.

Further illustrations of the present invention are provided by the following examples:

### EXAMPLE 1

### Preparation and Molding into a Film of a Segmented 88/12 l-Lactide/Trimethylene Copolymer (PLTMC)

The copolymer was prepared following the teaching of U.S. Pat. No. 6,342,065 by the two-step copolymerization of 1-lactide (LL) with trimethylene carbonate (TMC) in the presence of 1,3-propanediol and stannous octanoate as the initiator and catalyst, respectively. The polymer was isolated, ground, dried, and heated above 80° C. under reduced pressure to remove residual monomer. The polymer was characterized for identity (IR), thermal properties (DSC), and molecular weight by GPC(CH₂Cl₂). The polymer was shown to have a Tm=175° C. and Mw=160 kDa. The copolymer was then compression molded into a 0.1 mm-thick film at 180° C.

### EXAMPLE 2

### C-Succinylation of PLTMC

The polymer film from Example 1 was treated with a dry solution of maleic anhydride (15 percent concentration) and benzoyl peroxide (1.5 percent concentration) in a mixture of 3:1 cyclohexane and tetrahydrofuran at 50° C. for four hours. At the conclusion of this period, the film was removed, rinsed with a mixture of cyclohexane and tetrahydrofuran, dried under reduced pressure at 25° C. for one hour, and then 40° C. until a constant weight was attained. The presence of the anhydride groups on the polymer surface was verified using FTIR in the reflectance mode.

Preferred embodiments of the invention have been described using specific terms and devices. The words and terms used are for illustrative purposes only. The words and terms are words and terms of description, rather than of limitation. It is to be understood that changes and variations may be made by those of ordinary skill art without departing from the spirit or scope of the invention, which is set forth in the following claims. In addition it should be understood that aspects of the various embodiments may be interchanged in whole or in part. Therefore, the spirit and scope of the appended claims should not be limited to descriptions and examples herein.

What is claimed is:

1. A surface functionalized absorbable medical device comprising succinic acid anhydride groups attached to constituent polymeric chains at the surface of the medical device through carbon-carbon covalent single bonds.

2. A surface functionalized absorbable medical device as set forth in claim 1 wherein the succinic anhydride groups are hydrolyzed to form dicarboxylic groups.

3. A surface functionalized absorbable medical device as set forth in claim 1 wherein the succinic anhydride groups are reacted with at least one basic compound to form amic acid or imide derivatives.

4. A surface functionalized absorbable medical device as set forth in claim 2 in the form of a fibrous construct wherein the dicarboxylic groups are reacted with a water-soluble calcium-containing compound to create a surface with ionically immobilized calcium ions.

5. A surface functionalized absorbable medical device as set forth in claim 4 for use as a scaffold for bone tissue formation.

6. A surface functionalized absorbable medical device as set forth in claim 1 further comprising homosuccinic acid anhydride groups attached to constituent polymeric chains at the surface of the medical device through carbon-carbon covalent single bonds.

7. A process for producing a functionalized polymeric surface comprising the step of reacting a polymeric surface with a maleic anhydride solution containing a free-radical initiator, thereby producing succinic acid anhydride groups covalently bonded to the constituent polymer of the surface.

8. A process as set forth in claim 7 wherein the maleic anhydride solution further contains an activator for the free-radical initiator.

9. A process for producing a functionalized polymeric surface comprising the step of reacting a polymeric surface with maleic anhydride in the presence of a high-energy radiation source selected from the group consisting of ultraviolet rays, gamma rays, and electron beam, thereby producing succinic acid anhydride groups covalently bonded to the constituent polymer of the surface.

10. A surface functionalized absorbable medical device comprising homosuccinic acid anhydride groups attached to constituent polymeric chains about the surface of the medical device through carbon-carbon covalent single bonds.

11. A surface functionalized absorbable medical device as set forth in claim 10 wherein the homosuccinic anhydride groups are hydrolyzed to form dicarboxylic acid groups.

12. A process for producing a functionalized polymeric surface comprising the steps of pretreating a polymeric surface with a solution of itaconic anhydride and a free radical initiator, and subsequently heating above 25° C. to covalently react the double bond of the anhydride with the constituent polymer chain of the polymeric surface, thereby yielding homosuccinic anhydride side groups.

13. A process for producing a functionalized polymeric surface comprising the steps of pretreating the surface with a solution of itaconic anhydride, drying under nitrogen, and irradiating the surface with a high-energy radiation source selected from the group consisting of ultraviolet rays, gamma rays, and electron beam.
